(19) United States
(12) Patent Application Publication
(10) Pub. No.: US 2005/0154984 A1
(43) Pub. Date: Jul. 14, 2005

(54) Interface manager and methods of operation in a storage network

(76) Inventors: Steven Maddocks, Windsor, CO (US); Jeffrey Dicorpo, San Carlos, CA (US); Bill Torrey, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/757,757

(22) Filed: Jan. 14, 2004

(51) Int. Cl. G06F 3/00

(52) U.S. Cl. 715/700

(57) ABSTRACT

Interface manager and methods of operation in a storage network. In an exemplary implementation, a storage network comprises an automated storage system including data access drives and transfer robotics. A plurality of interface controllers are operatively associated with the data access drives and transfer robotics. An interface manager is communicatively coupled to each of the plurality of interface controllers. Computer-readable program code is provided in computer-readable storage at the interface manager, the computer-readable program code aggregating configuration information for the data access drives and transfer robotics.

### RELATED APPLICATION

This application is related to co-owned U.S. patent application Ser. No. ______ for “USER INTERFACE FOR A STORAGE NETWORK” of Maddocks et al. (Attorney Docket No. HP1-704US; Client Docket No. HP200315423-1), filed the same day as the present application.

### TECHNICAL FIELD

This invention relates to storage systems in general, and more specifically, to an interface manager for automated storage systems.

### BACKGROUND

Automated storage systems are commonly used to store large volumes of data on various types of storage media, such as magnetic tape cartridges, optical storage media, and hard disk drives, to name only a few examples. System devices in the storage system can be logically configured or “mapped” for user access via one or more network connections. For example, the users may be given access to one or more data access drives, for read and/or write operations, and to transfer robotics to move the storage media between storage cells and the data access drives.

A network administrator logically maps the storage system by connecting to internal routers for the various system devices and configuring each of the internal routers for access via the network connections. This can be a time-consuming and error prone process, particularly in large storage systems. In addition, the network administrator has to understand the physical layout of the storage system. If the physical layout changes (e.g., a drive is taken offline), the network administrator has to manually update the logical map. If a network connection is added, the network administrator has to manually assign a logical map to the new network connection.

Oftentimes, the network administrator will configure a default map that can automatically be assigned to new network connections so that the network administrator does not have to individually configure new network connections. However, the system devices may receive conflicting commands from these new network connections that were not properly configured for use in the storage system. For example, one network connection may issue a “rewind” command to a drive while another network connection is using the same drive for a backup operation.

### SUMMARY

An exemplary storage network comprises an automated storage system including data access drives and transfer robotics. A plurality of interface controllers are operatively associated with the data access drives and transfer robotics. An interface manager is communicatively coupled to each of the plurality of interface controllers. Computer-readable program code is provided in computer-readable storage at the interface manager, the computer-readable program code aggregating configuration information for the data access drives and transfer robotics.

An exemplary method of operation comprises: receiving device information from a plurality of interface controllers operatively associated with storage system devices, generating a logical map identifying at least some of the storage system devices based on the device information, and assigning the logical map to at least one host for access to the storage system devices.

### BRIEF DESCRIPTION OF THE DRAWINGS

FIG. 1 is a schematic illustration of an exemplary implementation of a storage network;

FIG. 2 is a functional diagram illustrating an exemplary implementation of an interface manager;

FIG. 3 is a flowchart of exemplary operations to implement an interface manager in a storage system; and

FIG. 4 is another flowchart of exemplary operations to implement an interface manager in a storage system.

### DETAILED DESCRIPTION

Briefly, an implementation of the invention enables a network administrator to logically map a storage system without having to understand the physical layout of the storage system. In addition, if the physical layout of the storage system changes, the network administrator can readily update the logical map of the storage system without having to individually configure each of the internal routers. This and other implementations are described in more detail below with reference to the figures.

Exemplary System

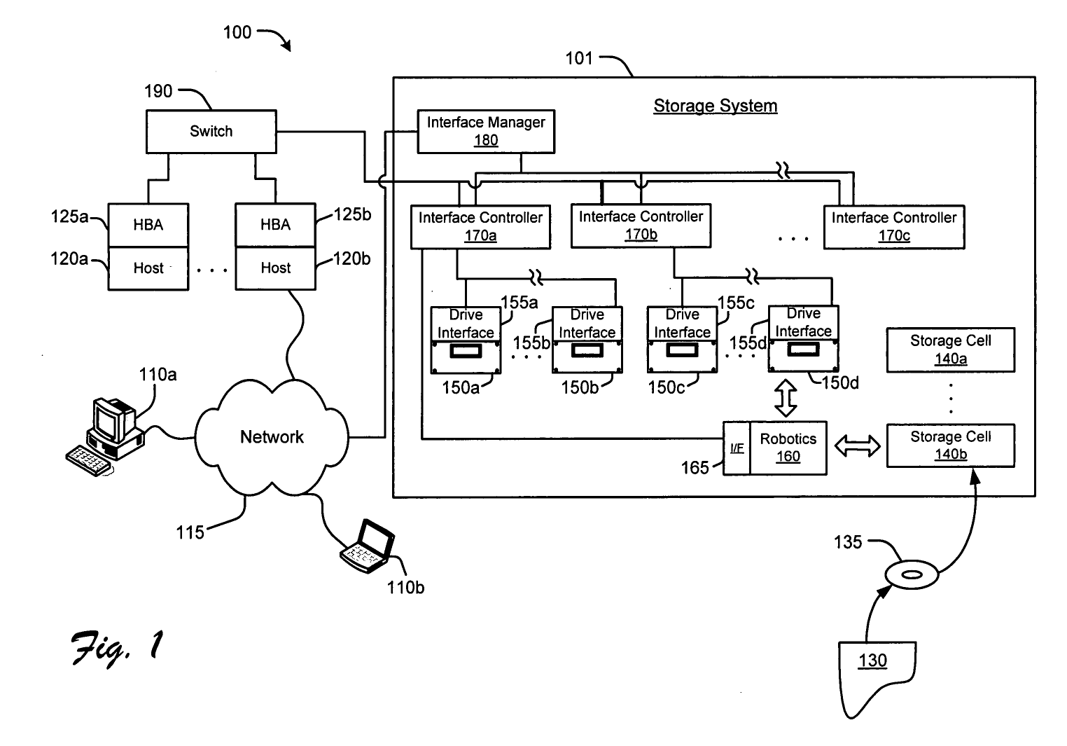

An exemplary storage area network (SAN), otherwise referred to as storage network 100, is shown in FIG. 1. The storage network 100 may be implemented in a private, dedicated network such as, e.g., a Fibre Channel (FC) switching fabric. Alternatively, portions of the storage network 100 may be implemented using public communication networks pursuant to a suitable communication protocol. Storage network 100 is shown in FIG. 1 including an automated storage system 101 which may be accessed by one or more clients 110a, 110b and at least one host 120a, 120b.

As used herein, the term “host” comprises one or more computing systems that provide services to other computing or data processing systems or devices. For example, clients 110a, 110b may access the storage device 101 via one of the hosts 120a, 120b. Hosts 120a, 120b include one or more processors (or processing units) and system memory, and are typically implemented as server computers.

Clients 110a, 110b can be connected to one or more of the hosts 120a, 120b and to the storage system 101 directly or over a network 115, such as a Local Area Network (LAN) and/or Wide Area Network (WAN). Clients 110a, 110b may include memory and a degree of data processing capability at least sufficient to manage a network connection. Typically, clients 110a, 110b are implemented as network devices, such as, e.g., wireless devices, desktop or laptop computers, workstations, and even as other server computers.

As previously mentioned, storage network 100 includes an automated storage system 101 (hereinafter referred to as a “storage system”). Data 130 is stored in the storage system 101 on storage media 135, such as, magnetic data cartridges, optical media, and hard disk storage, to name only a few examples.

The storage system 101 may be arranged as one or more libraries (not shown) having a plurality of storage cells 140a, 140b for the storage media 135. The libraries may be modular (e.g., configured to be stacked one on top of the other and/or side-by-side), allowing the storage system 101 to be readily expanded.

Before continuing, it is noted that the storage system 101 is not limited to any particular physical configuration. For example, the number of storage cells 140a, 140b may depend upon various design considerations. Such considerations may include, but are not limited to, the desired storage capacity and frequency with which the computer-readable data 130 is accessed. Still other considerations may include, by way of example, the physical dimensions of the storage system 101 and/or its components. Consequently, implementations in accordance with the invention are not to be regarded as being limited to use with any particular type or physical layout of storage system 101.

The storage system 101 may include one or more data access drives 150a, 150b, 150c, 150d (also referred to generally by reference 150) for read and/or write operations on the storage medium 135. In one exemplary implementation, each library in the storage system 101 is provided with at least one data access drive 150. However, in other implementations data access drives 150 do not need to be included with each library.

Transfer robotics 160 may also be provided for transporting the storage media 135 in the storage system 101. Transfer robotics 160 are generally adapted to retrieve storage media 135 (e.g., from the storage cells 140a, 140b), transport the storage media 135, and eject the storage media 135 at an intended destination (e.g., one of the data access drives 150).

Various types of transfer robotics 160 are readily commercially available, and embodiments of the present invention are not limited to any particular implementation. In addition, such transfer robotics 160 are well known and further description of the transfer robotics is not needed to fully understand or to practice the invention.

It is noted that the storage system 101 is not limited to use with data access drives and transfer robotics. Storage system 101 may also include any of a wide range of other system devices that are now known or that may be developed in the future. For example, a storage system including fixed storage media such as a redundant array of independent disks (RAID), may not include transfer robotics or separate data access drives.

Each of the system devices, such as the data access drives 150 and transfer robotics 160, are controlled by interface controllers 170a, 170b, 170c. The interface controllers are operatively associated with the system devices via the corresponding device interfaces. For example, interface controller 170a is connected to drive interfaces 155a, 155b for data access drives 150a, 150b, respectively. Interface controller 170a is also connected to the robotics interface 165 for transfer robotics 160. Interface controller 170b is connected to drive interfaces 155c, 155d for data access drives 150c, 150d, respectively. Interface controller 170b is also connected to the robotics interface 165 for transfer robotics 160.

In an exemplary implementation, the interface controllers 170a, 170b, 170c may be implemented as Fibre Channel (FC) interface controllers and the device interfaces 155a, 155b, 155c, 155d may be implemented as small computer system interface (SCSI) controllers. However, the invention is not limited to use with any particular type of interface controllers and/or device interfaces.

Storage system 101 also includes an interface manager 180. Interface manager 180 is communicatively coupled, internally, with the interface controllers 170a, 170b, 170c, and aggregates device information and management commands for each of the system devices. The interface manager 180 also allocates the system devices as uniquely identified logical units or LUNs. Each LUN may comprise a contiguous range of logical addresses that can be addressed by mapping requests from the connection protocol used by the hosts 120a, 120b to the uniquely identified LUN. Of course the invention is not limited to LUN mapping and other types of mapping now known or later developed are also contemplated as being within the scope of the invention.

Storage system 101 is also communicatively coupled, externally, to at least one of the hosts 120a, 120b and/or clients 110a, 110b, e.g., via network 115. In an exemplary implementation, the hosts 120a, 120b are connected by I/O adapters 125a, 125b, such as, e.g., host bus adapters (HBA), to a switch 190. Switch 190 may be implemented as a SAN switch, and is connected to the storage system 101, e.g., at the interface controllers 170a, 170b, 170c. In any event, the hosts 120a, 120b and clients 110a, 110b have access to system devices, such as the data access drives 150 and transfer robotics 160, via the interface manager 180.

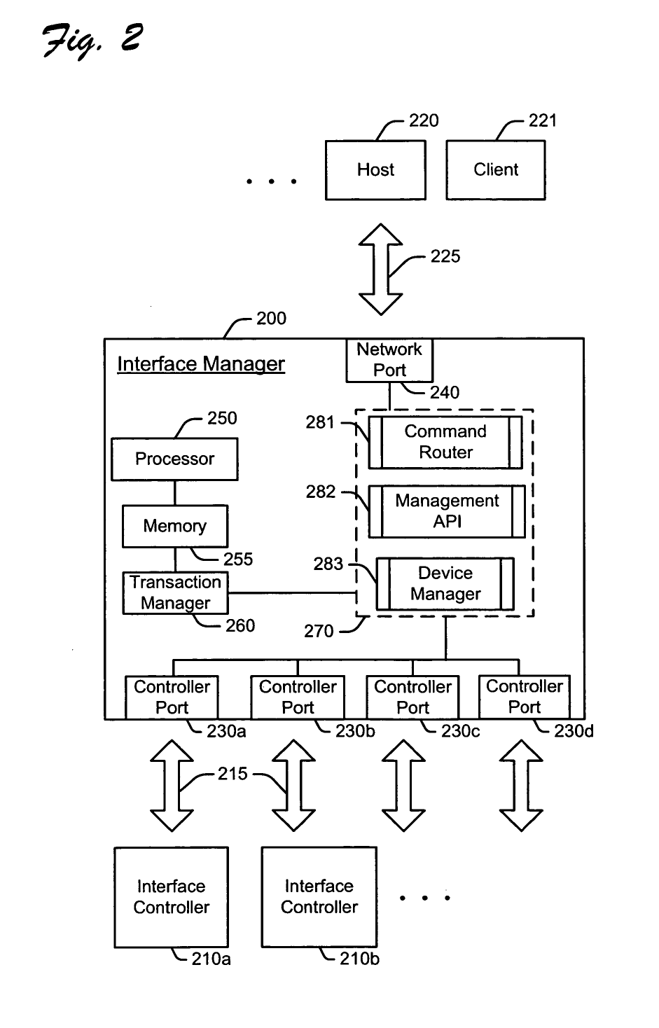

FIG. 2 is a functional diagram illustrating in more detail an exemplary interface manager 200 as it may be implemented in a storage system (e.g., storage system 101 in FIG. 1) to aggregate device information and management commands. Interface manager 200 may be implemented in hardware, software and/or firmware which process computer-readable data signals embodied in one or more carrier waves.

Interface manager 200 communicatively couples interface controllers 210a, 210b (e.g., over communication links 215) to host(s) 220 and/or client(s) 221 (e.g., over communication links 225). Accordingly, the interface manager 200 includes a plurality of I/O modules or controller ports 230a, 230b, 230c, 230d (also referred to generally by reference 230). The controller ports 230 facilitate data transfer between the respective interface controllers 210a, 210b. Interface manager 200 also includes at least one network port 240.

In an exemplary implementation, the controller ports 230 and network port 240 may employ fiber channel technology, although other bus technologies may also be used. Interface manager 200 may also include a converter (not shown) to convert signals from one bus format (e.g., Fibre Channel) to another bus format (e.g., SCSI).

It is noted that auxiliary components may also be included with the interface manager 200, such as, e.g., power supplies (not shown) to provide power to the other components of the interface manager 200. Auxiliary components are well understood in the art and further description is not necessary to fully understand or to enable the invention.

Interface manager 200 includes a processor (or processing units) 250 and computer-readable storage or memory 255 (e.g., dynamic random access memory (DRAM) and/or Flash memory) and may be implemented on a computer board. Interface manager 200 also includes a transaction manager 260, which may be implemented as an integrated circuit (IC), such as an application-specific integrated circuit (ASIC). The transaction manager 260 handles all transactions to and from the interface manager 200. For example, the transaction manager 260 maintains a map of memory 255, computes parity, and facilitates cross-communication with the interface controllers 210a, 210b and the hosts 220 and/or clients, 221.

In one exemplary implementation, the transaction manager employs a high-level packet protocol to exchange transactions in packets. The transaction manager may also perform error correction on the packets to ensure that the data is correctly transferred between the interface controllers 210a, 210b and the hosts 220 and/or clients 221. The transaction manager may also provide an ordering mechanism to support an ordered interface for proper sequencing of the transactions.

Transactions are handled by the interface manager according to a pipeline 270. The pipeline 270 is implemented as software and/or firmware stored in memory 255 and executed by processor (or processing units) 250. The pipeline 270 may include a number of functional modules to facilitate device configuration and command routing. For example, the pipeline may include a command router 281, a management application program interface (API) 282, and a device manager 283.

Transactions from the hosts 220 and/or clients 221 are processed by the command router. Command router 281 formats the transactions into a format that is suitable for the interface controllers 210a, 210b. Likewise, command router 281 formats transactions from the interface devices 210a, 210b into a format that is suitable for the hosts 220 and/or clients 221.

In an exemplary implementation, transactions between the interface manager 200 and the hosts 220 and/or clients 221 may be based on the Simple Object Access Protocol (SOAP). SOAP is a messaging protocol used to encode transactions for transfer over a network using any of a variety of Internet protocols (e.g., HTTP, SMTP, MIME). SOAP transactions do not need to be formatted for use with any particular operating system, making SOAP transactions commonplace in network environments. According to such an implementation, the command router 281 formats SOAP transactions from the hosts 220 and/or clients 221 into a format suitable for the interface controllers 210a, 210b (e.g., as SCSI packets). However, the command router 281 is not limited to use with transactions of any particular format.

The management API 282 is implemented in the pipeline 270 as the core logic of the interface manager 200. Management API 282 includes routines and/or protocols for interfacing between the interface controllers 210a, 210b and the hosts 220 and/or clients 221. Exemplary routines and/or protocols may include rebooting one or more of the system devices, interrogating system devices, determining the status of system devices, generating logical maps of the storage system, and scheduling system devices for access by the hosts 220 and/or clients 221, to name only a few exemplary routines that may be implemented by the management API 282.

The device manager 283 is implemented in the pipeline 270 to handle transactions between the interface controllers 210a, 210b and the management API 282. Device manager 283 formats and communicates transactions from the management API 282 to the designated interface controller(s) 210a, 210b. Device manager 283 also formats and communicates messages it receives from the interface controllers 210a, 210b for processing by the management API.

Before continuing, it is noted that exemplary interface manager 200 is shown and described herein merely for purposes of illustration and is not intended to limit the interface manager to any particular implementation. For example, device manager, command router, and management API do not need to be provided as separate functional components. In addition, other functional components may also be provided and are not limited to the command router, management API, and device manager.

Exemplary Operations

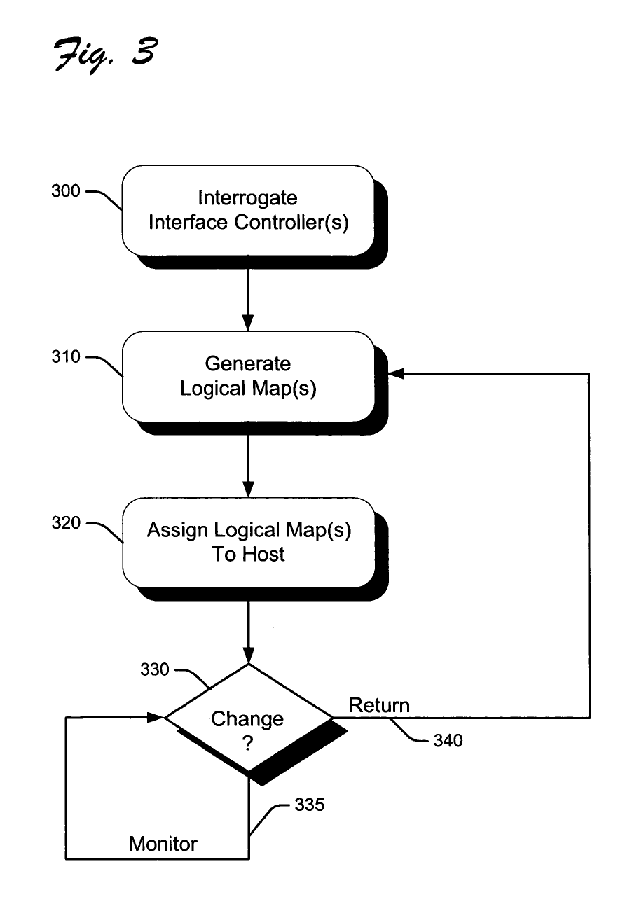

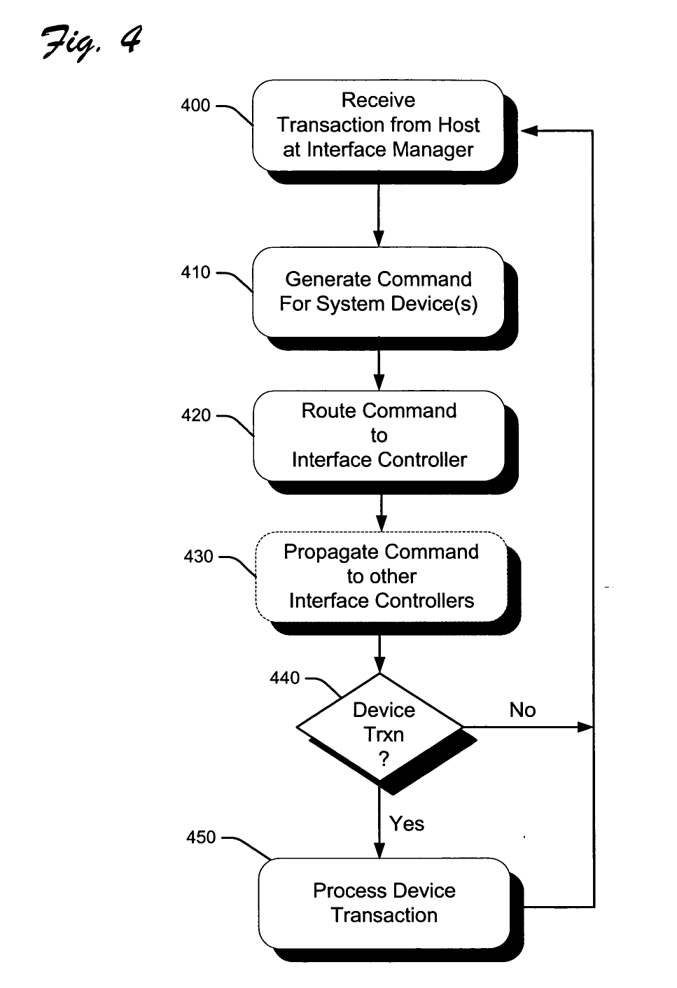

FIG. 3 and FIG. 4 are flowcharts illustrating exemplary operations to implement an interface manager for a storage system (such as the interface manager 200 shown in FIG. 2). In one embodiment, the operations may be implemented on a processor (or processing units) of the interface manager, such as processor 250 shown in FIG. 2. In alternate embodiments one or more of the operations described in FIG. 3 and FIG. 4 may be implemented at interface controllers, hosts, or another processor (or processing units) in the storage network.

FIG. 3 illustrates exemplary operations to logically configure or map a storage system (e.g., storage system 101 in FIG. 1) for access via a host. In operation 300, the interface manager interrogates a plurality of the interface controllers in the storage system. Alternatively, the interface controllers may report changes in state to the interface manager. In any event, the interface manager obtains any of a variety of different types of device information from the interface controllers, such as the number and type of devices connected to the interface controller(s), capacity of the data access drives, connection type, security or permissions, and device status, to name only a few examples.

In operation 310, the interface manager generates logical map(s) of all or some of the system devices in the storage system based at least in part on the device information obtained during operation 300. In an exemplary implementation, a plurality of logical devices (also called logical units or LUNs) may be allocated within the storage system. Each LUN comprises a contiguous range of logical addresses that can be addressed by host devices by mapping requests from the connection protocol used by the host device to the uniquely identified LUN.

In operation 320, the logical map(s) are assigned to one or more of the hosts. The logical maps allow the hosts to access one or more of the system devices. In an exemplary implementation, a user interface (e.g., a graphical user interface or GUI) is provided to allow a network administrator modify and/or to assign the logical maps to the hosts.

In operation 330, the interface manager monitors the storage system for a change in state of the devices (e.g., if a device is taken offline or when the storage system is re-cabled). In an exemplary implementation, the interface manager may interrogate the interface controllers to determine a change in state. Alternatively, the interface controllers may report changes in state to the interface manager. The interface manager may continue to monitor the interface controllers for a change in state, as illustrated by loop 335. If a change of state affects the logical mapping, the interface manager may return 340 to operation 310 to update the logical maps (or generate new maps). The logical map presented to the host remains the same regardless of the physical changes to the library so that backup applications do not need to be reconfigured to account for new device paths.

FIG. 4 illustrates exemplary operations to process transactions for system devices in a storage system. According to this implementation, at least one host is logically mapped to the interface manager, e.g., as described above with reference to FIG. 3.

In operation 400, the interface manager receives a transaction from the host. The transaction may include, for example, “read” or “write” commands, “rewind” commands, “reset” commands, to name only a few transactions types.

In operation 410, the interface manager generates a command for at least one of the system devices based on the transaction received in operation 400. For purposes of illustration, if the transaction includes a request to start a “backup” operation, command(s) are generated (e.g., by pipeline 270 in FIG. 2) for the transfer robotics to deliver storage media to one of the data access drives, and commands also are generated for the data access drives to write data on the storage media. As another illustration, the transaction may include a configuration command. For example, a network administrator may access the interface manager to configure one or more of the system devices.

In operation 420, the command(s) generated in operation 410 are routed to the interface controller(s) to be executed. Optionally, the commands may be propagated to a plurality (e.g., all) of the interface controllers. Such an operation is illustrated by operation 430, shown by dashed lines in FIG. 4. Operation 430 may be selected, for example, by a network administrator to concurrently update the configuration of a plurality of interface controllers without having to configure the interface controllers individually.

In operation 440, If the interface manager receives a transaction from one of the system devices, in operation 450 the interface manager processes the device transaction in a manner similar to that described above for processing host transactions. For example, a data access drive may respond that a backup operation was successful. Alternatively, at operation 440 the interface manager may receive another transaction from one of the hosts and return to operation 400 to process the host transaction.

It is noted that the exemplary operations shown and described with reference to FIG. 3 and FIG. 4 are not intended to limit the scope of the invention to any particular order. In addition, the operations are not limited to closed loop operations. In other exemplary implementations, operations may end (e.g., if the system is powered off). Still other implementations are also contemplated, as will be readily apparent to those skilled in the art after having become familiar with the teachings of the invention.

In addition to the specific implementations explicitly set forth herein, other aspects and implementations will also be apparent to those skilled in the art from consideration of the specification disclosed herein. It is intended that the specification and illustrated implementations be considered as examples only, with a true scope and spirit of the following claims.

1. A storage network comprising:
an automated storage system including data access drives and transfer robotics;
a plurality of interface controllers operatively associated with the data access drives and transfer robotics;
an interface manager communicatively coupled to each of the plurality of interface controllers; and
computer-readable program code provided in computer-readable storage at the interface manager, the computer-readable program code aggregating configuration information for the data access drives and transfer robotics.

2. The storage network of claim 1 wherein the computer-readable program code includes a pipeline to route management commands to the plurality of interface controllers.

3. The storage network of claim 1 wherein the computer-readable program code includes a command router to format transactions for the interface controllers.

4. The storage network of claim 1 wherein the computer-readable program code includes a management application program interface (API) to generate management commands for the plurality of interface controllers.

5. The storage network of claim 4 wherein the management API generates at least the following management commands: reboot, interrogate, and status.

6. The storage network of claim 4 wherein the management API generates a logical map of the automated storage system.

7. The storage network of claim 4 wherein the management API schedules access to the data access drives and transfer robotics.

8. The storage network of claim 1 wherein the computer-readable program code includes a device manager to communicate with the plurality of interface controllers.

9. The storage network of claim 1 further comprising a transaction manager for sequencing transactions at the interface manager.

10. The storage network of claim 1 further comprising a logical map of the automated storage system, the logical map generated by the interface manager.

11. The storage network of claim 10 wherein the data access drives and transfer robotics are identified by a fibre channel port and logical units (LUNs) in the logical map.

12. A method comprising:
receiving device information from a plurality of interface controllers operatively associated with storage system devices;
generating a logical map identifying at least some of the storage system devices based on the device information; and
assigning the logical map to at least one host for access to the storage system devices.

13. The method of claim 12 further comprising aggregating configuration information from each of the storage system devices for the logical map.

14. The method of claim 12 further comprising propagating management commands to each of the plurality of interface controllers.

15. The method of claim 12 further comprising routing transactions from the at least one host to at least one of the interface controllers.

16. The method of claim 12 further comprising formatting transactions from the at least one host for a designated interface controller.

17. The method of claim 12 further comprising scheduling access by the at least one host to the storage system devices.

18. The method of claim 12 further comprising identifying the storage system devices in the logical map as logical units (LUNs).

19. An automated storage system comprising:
control means for controlling a plurality of system devices in the automated storage system;
software means for aggregating configuration information for the control means; and
interfacing means for interfacing between the control means and the software means.

20. The automated storage system of claim 19 wherein the interfacing means includes means for sequencing transactions to the control means.

21. A storage network comprising:
an automated storage system including data access drives and transfer robotics;
a plurality of interface controllers operatively associated with the data access drives and transfer robotics;
an interface manager communicatively coupled to each of the plurality of interface controllers, the interface manager aggregating configuration information for the data access drives and transfer robotics; and
a pipeline provided as computer readable program code in computer-readable storage at the interface manager, the pipeline including:
a command router to format transactions for the interface controllers;
a management application program interface (API) to generate management commands for the plurality of interface controllers; and
a device manager to communicate with the plurality of interface controllers.

22. The storage network of claim 21 wherein the management API generates at least the following management commands: reboot, interrogate, and status.

23. The storage network of claim 21 wherein the management API generates a logical map of the automated storage system.

24. The storage network of claim 21 wherein the management API schedules access to the data access drives and transfer robotics.
